(19) United States
(12) Patent Application Publication
(10) Pub. No.: US 2022/0049370 A1
(43) Pub. Date: Feb. 17, 2022

(54) METAL SHEET, PLATED SHEET, PRODUCTION METHOD OF PLATED SHEET AND PRODUCTION METHOD OF PLATED MATERIAL

(71) Applicant: TANAKA KIKINZOKU KOGYO K.K., Tokyo (JP)

(72) Inventors: Tasuku ARIMOTO, Kanagawa (JP); Junichi IMAI, Kanagawa (JP); Masaru SAITO, Kanagawa (JP)

(73) Assignee: TANAKA KIKINZOKU KOGYO K.K., Tokyo (JP)

(21) Appl. No.: 17/418,361

(22) PCT Filed: Dec. 26, 2019
(86) PCT No.: PCT/JP2019/051201

§ 371 Date: Jun. 25, 2021

(30) Foreign Application Priority Data
Dec. 27, 2018 (JP) 2018-245929

(51) Int. Cl. C25D 7/00; C25D 3/50; C25D 5/48

(52) U.S. Cl. CPC C25D 7/00; C25D 5/48; C25D 3/50

(57) ABSTRACT

The invention relates to a metal sheet which has a plurality of parts to be plated, a frame part and connector parts connecting the parts to be plated and the frame part and in which the plurality of the parts to be plated, the frame part and the connector parts are made of a metal.

### TECHNICAL FIELD

The present invention relates to a metal sheet, a plated sheet, a production method of a plated sheet and a production method of a plated material.

### BACKGROUND ART

Plated materials obtained by forming an electroplated layer on the surface of a metal material in the sheet shape by electroplating have been known.

For example, in the Examples of PTL 1, an electrode obtained by forming an electroplated layer of Pt or the like on the surface of a substrate made of Ti is disclosed.

Methods for obtaining such a plated material include a method of processing a metal sheet into the shape of the plated material to be produced and then electroplating and a method of electroplating a metal sheet and then processing the metal sheet into the shape of the plated material to be produced through blanking or the like.

### CITATION LIST

### Patent Literature

PTL 1: JP-A-2017-51935

### SUMMARY OF INVENTION

### Technical Problem

The method of processing a metal sheet into the shape of the plated material to be produced and then electroplating, however, has the following problems.

First, a plurality of materials to be plated are generally obtained from a metal sheet by blanking or the like in the method, and the method has problems because a lot of man-hours are required in the step of collecting the obtained materials to be plated and because scratches are caused due to rubbing among the materials to be plated.

Moreover, a plurality of materials to be plated are generally fixed on a jig such as a rack before electroplating, and electroplating is conducted by applying a current to the materials to be plated from the jig. There is a problem because a lot of man-hours are required in the step of fixing the materials to be plated one after another on the jig.

Furthermore, there is a problem because the portions of the materials to be plated which are in contact with the jig cannot come into contact with the plating solution in the electroplating step and because the electroplated layer is thus not formed on the portions. There is also a problem of a current flow mark on the electroplated layer around the portions of the materials to be plated which are in contact with the jig.

When there is such a defect of the electroplated layer in an electroplated material, the surface area of the electroplated layer is reduced, and the effects of the formed electroplated layer may not be obtained sufficiently. Depending on the use of the plated material, a problem such as corrosion of the part to be plated from the defect of the electroplated layer may arise. A defect or a current flow mark of the electroplated layer is not preferable also in view of the appearance.

In addition, there is a problem because it is required to individually pack the obtained plated materials to avoid causing scratches or the like and because a lot of man-hours are required also in the packing step.

The method of electroplating a metal sheet and then processing the metal sheet into the shape of the plated material to be produced through blanking or the like has the following problems.

First, there is a problem of a large amount of loss of the plating metal because the entire metal sheet is electroplated in the step of electroplating the metal sheet and thus the portions other than the plated materials (the scrap portions) are also electroplated. This problem is significant when the plating metal is an expensive metal such as a noble metal.

Moreover, there is a problem because the end face (section) of the obtained plated material does not have the electroplated layer in the step of blanking the electroplated metal sheet or the like.

Furthermore, there are problems because a lot of man-hours are required in the step of collecting the obtained plated materials and because scratches are made due to rubbing among the collected plated materials.

Plated materials obtained by blanking are needed to be degreased, and a plurality of the plated materials are fixed one after another on the jig for degreasing in the step. Thus, there is a problem of a lot of man-hours.

In addition, there is a problem because it is required to individually pack the obtained plated materials to avoid causing scratches or the like and because a lot of man-hours are required also in the packing step.

As explained above, the conventional methods for producing a plated material having an electroplated material have problems of failures such as a defect or a current flow mark of the electroplated layer and problems of the low production efficiency due to the decrease in the yield rate as a result of scratches and due to the increase in the man-hours in the production steps.

In view of the above points, an object of the invention is to provide a metal sheet and a plated sheet from which a plated material in which occurrence of a defect or a current flow mark of the electroplated layer is inhibited can be produced efficiently.

Another object of the invention is to provide a method for producing the plated sheet.

Another object of the invention is to provide a method for efficiently producing a plated material in which occurrence of a defect or a current flow mark of the electroplated layer is inhibited.

### Solution to Problem

A metal sheet of the invention which achieves the objects is a metal sheet which has a plurality of parts to be plated, a frame part and connector parts connecting the parts to be plated and the frame part and in which the parts to be plated, the frame part and the connector parts are made of a metal.

The metal sheet according to an aspect of the invention is a parts-to-be-plated-integrated electroplating jig used for forming an electroplated layer at least on the surfaces of the parts to be plated by applying a current to the parts to be plated from the frame part through the connector parts.

In the metal sheet according to an aspect of the invention, the connector parts have a shape which becomes narrower towards the part to be plated side from the frame part side.

In the metal sheet according to an aspect of the invention, the widths of the portions of the connector parts which are connected to the parts to be plated are 1 mm or less.

In the metal sheet according to an aspect of the invention, two or more connector parts are connected to a part to be plated.

The plated sheet of the invention has any of the above metal sheets and an electroplated layer formed on the surface of the metal sheet.

In the plated sheet according to an aspect of the invention, the electroplated layer is made of a noble metal.

An aspect of the method for producing a plated sheet of the invention includes a step of electroplating any of the above metal sheets by applying a current from the frame part and forming an electroplated layer on the surface of the metal sheet.

An aspect of the method for producing a plated material of the invention includes a step of electroplating any of the above metal sheets by applying a current from the frame part, forming an electroplated layer on the surface of the metal sheet and obtaining a plated sheet and a step of separating the parts to be plated and the connector parts of the plated sheet.

An aspect of the method for producing a plated material of the invention includes a step of separating the parts to be plated and the connector parts of any of the above plated sheets.

An aspect of the method for producing a plated material of the invention further includes a step of collecting a metal contained in the electroplated layer from a scrap obtained after separating the parts to be plated and the connector parts of the plated sheet.

In the method for collecting a plating metal of the invention, a metal contained in the electroplated layer is collected from a scrap obtained after separating the parts to be plated and the connector parts of any of the above plated sheets.

### Advantageous Effects of Invention

When the metal sheet or the plated sheet of the invention is used, a plated material in which occurrence of a defect or a current flow mark of the electroplated layer is inhibited can be produced efficiently.

Moreover, according to the method for producing a plated material of the invention, a plated material in which occurrence of a defect or a current flow mark of the electroplated layer is inhibited can be produced efficiently.

### BRIEF DESCRIPTION OF DRAWINGS

FIG. 1 is a top view of the metal sheet according to an embodiment of the invention.

FIG. 2 is a top view of a plated material produced using the metal sheet according to an embodiment of the invention.

FIG. 3 is a cross section of FIG. 2 along line X-X.

FIG. 4 is a top view of a modification example of the metal sheet according to an embodiment of the invention.

FIG. 5 is a top view of a modification example of the metal sheet according to an embodiment of the invention.

FIG. 6 is a top view of a modification example of the metal sheet according to an embodiment of the invention.

FIG. 7 is an enlarged view around a connector part of the metal sheet according to an embodiment of the invention.

### DESCRIPTION OF EMBODIMENTS

Embodiments of the invention are explained in detail below. In this regard, however, the invention is not limited to the embodiments explained below. In the drawings below, the parts/portions having a same function are sometimes explained using a same reference sign, and overlapping explanations are sometimes omitted or simplified. The embodiments illustrated in the drawings are schematically illustrated for clearly explaining the invention and do not always accurately show the sizes or the scales of the actual products.

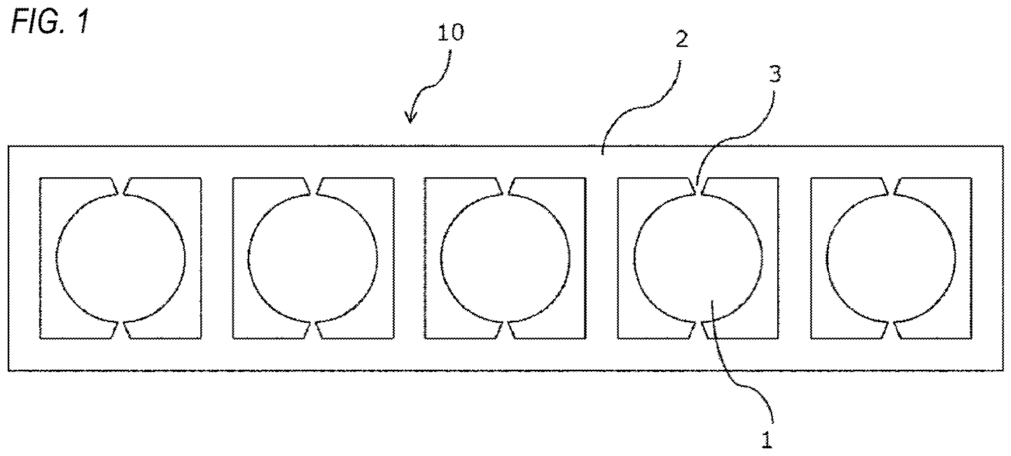

FIG. 1 is a top view of a metal sheet 10 according to an embodiment of the invention. The metal sheet 10 of the embodiment has a plurality of parts to be plated 1, a frame part 2 and connector parts 3 connecting the parts to be plated 1 and the frame part 2.

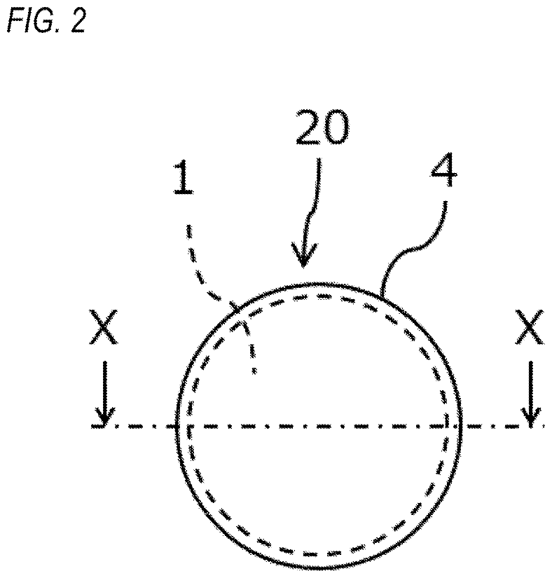

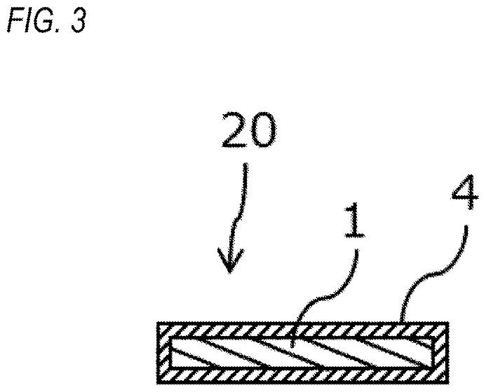

FIG. 2 is a top view of a plated material 20 produced using the metal sheet of the embodiment. FIG. 3 is a cross section of FIG. 2 along line X-X.

The metal sheet 10 of the embodiment can be preferably used for producing a plated material 20 having an electroplated layer 4 (also simply called “plated material 20” below). When the metal sheet 10 of the embodiment is used, a plated material 20 in which occurrence of a defect or a current flow mark of the electroplated layer 4 is inhibited can be produced efficiently.

To facilitate the understanding of the invention, an aspect of the method for producing a plated material using the metal sheet 10 of the embodiment is first explained below. In this regard, the method for producing a plated material using the metal sheet 10 of the embodiment is not limited to the method.

When the plated material 20 is produced using the metal sheet 10 of the embodiment, first, the metal sheet 10 is electroplated by applying a current from the frame part 2, and a plated sheet having the metal sheet 10 and the electroplated layer 4 formed on the surface of the metal sheet 10 is obtained.

The electroplating method is not particularly limited but can be conducted, for example, as follows.

First, the metal sheet 10 is fixed on a jig such as a rack. Here, the metal sheet 10 is fixed on the jig in a manner that the frame part 2 and the jig come into contact with each other and that the parts to be plated 1 are not in contact with the jig.

Next, at least the entire parts to be plated 1 of the metal sheet 10 are immersed in a plating bath, and electroplating is conducted by applying a current to the metal sheet 10 from the portion where the jig contacts the frame part 2. The electroplated layer 4 is thus formed on the surface of the metal sheet 10. Here, it is not necessary to form the electroplated layer 4 on the entire surface of the metal sheet 10, and the electroplated layer 4 should be formed at least on the surfaces of the parts to be plated 1.

When the frame part 2 and the connector parts 3 are also immersed in the plating bath, the electroplated layer is formed also on the surfaces of the frame part 2 and the connector parts 3. In this case, the electroplated layer 4 is not always formed on the portion of the frame part 2 which contacts the jig, but the electroplated layer 4 is formed at least on a part of the surface of the frame part 2. Depending also on the size of the frame part 2, the electroplated layer 4 is generally formed on, for example, 90% or more, 95% or more or 99% or more of the surface area of the frame part 2. In this regard, even when the electroplated layer is formed also on the surfaces of the frame part 2 and the connector parts 3, the metal contained in the electroplated layer 4 adhered to the surfaces of the frame part 2 and the connector parts 3 can be collected as described below.

The material of the electroplated layer 4 is not particularly limited, and a suitable metal can be selected depending on the use of the plated material 20 to be produced.

Although the electroplating method of the metal sheet 10 which is fixed on a rack has been explained above, the electroplating method is not limited to the method. For example, electrodes may be attached to the frame part 2 of the metal sheet 10 using clips, and electroplating may be conducted by applying a current to the metal sheet 10 from the portions where the electrodes and the frame part 2 are in contact with each other.

Next, a plated material 20 is obtained by separating the connector part 3 and the part to be plated 1 of the obtained plated sheet.

The method for separating the connector part 3 and the part to be plated 1 is not particularly limited, and for example, the parts may be separated using a machine or separated manually without using a machine.

According to the method, electroplating is conducted without bringing the jig into contact with the parts to be plated 1, and thus, the obtained plated material 20 does not have a defect or a current flow mark of the electroplated layer 4 due to contact with the jig. That is, as described above, by the method for obtaining a plated material through blanking or the like after electroplating a metal sheet, the obtained plated material does not have the electroplated layer on the end face. On the other hand, because blanking or the like is not conducted in the method for producing the plated material 20 using the metal sheet 10 of the embodiment, the obtained plated material 20 has the electroplated layer 4 also on the end face.

Moreover, as described above, by the method of electroplating after processing the metal sheet into the shape of the plated material to be produced, a defect or a current flow mark of the electroplated layer is caused at and around the portion in contact which the jig. On the other hand, because the jig is brought into contact with the frame part 2 in the method for producing the plated material 20 using the metal sheet 10 of the embodiment, such a defect or a current flow mark of the electroplated layer is not caused in the obtained plated material 20.

In addition, in the method for producing the plated material 20 using the metal sheet of the embodiment, time for fixing the materials to be plated on a rack one after another is not required, and thus man-hours can be reduced.

The electroplated layer 4 is generally adhered to the frame part 2 and the connector parts 3 of the plated sheet from which the parts to be plated 1 have been separated (the parts are together also simply called “scraps” below) as described above. Therefore, not disposing of the scraps and collecting the metal contained in the electroplated layer 4 adhered to the scraps are preferable in view of the costs and are particularly preferable when the electroplated layer 4 contains an expensive metal such as a noble metal. The method for collecting the metal contained in the electroplated layer 4 from the scraps is not particularly limited, and an appropriate method can be selected depending on the metal to be collected.

Although the metal sheet 10 may be electroplated after masking the metal sheet 10 so that the electroplated layer 4 is not formed on the scraps, it is not preferable because man-hours increase due to the masking operation and because the conduction of the metal sheet 10 and the jig becomes difficult. When the metal sheet 10 is electroplated after masking, small protrusions with sharp tips are sometimes formed on the surface of the electroplated layer 4 due to the interface between the metal sheet 10 and the masking material. In this case, for example, when the obtained plated material is used for an electrode or the like, the plated material comes into contact with another material and may cause damage of the material.

In the method for producing the plated material 20, the step of electroplating the metal sheet 10 and obtaining the plated sheet and the step of separating the connector parts 3 and the parts to be plated 1 of plated sheet and obtaining the plated material 20 do not always have to be conducted in succession. The steps do not have to be conducted by a same person, either.

For example, the plated sheet obtained by electroplating the metal sheet 10 may be shipped as it is, and the plated materials 20 may be obtained by separating the connector parts 3 and the parts to be plated 1 of the plated sheet at the recipient of the shipment. That is, a plurality of the plated materials 20 may be shipped in a state of being fixed on the frame part 2 through the connector parts 3 (in the state of the plated sheet). In this manner, only the plated sheet should be packed, and it is not necessary to individually pack the plated materials, resulting in a decrease in the man-hours of the packing step. Moreover, because scratches are not caused by the contacts among the plated materials, the yield rate increases.

The step of obtaining the plated material 20 by separating the connector parts 3 and the parts to be plated 1 of the plated sheet and the step of collecting the electroplated layer 4 adhered to the scraps do not always have to be conducted in succession and do not always have to be conducted by a same person, either.

For example, the step of recovering the electroplated layer 4 adhered to the scraps may be conducted by a third person such as a recycling company.

Next, the metal sheet 10 of the embodiment is explained.

As described above, the metal sheet 10 of the embodiment is a parts-to-be-plated-integrated electroplating jig used for forming the electroplated layer 4 at least on the surfaces of the parts to be plated 1 by applying a current to the parts to be plated 1 from the frame part 2 through the connector parts 3.

In the metal sheet 10 of the embodiment, the parts to be plated 1, the connector parts 3 and the frame part 2 are made of a metal. Thus, a current can be applied to the parts to be plated 1 from the jig which is in contact with the frame part 2, and the electroplated layer 4 can be formed on the parts to be plated 1. The metal constituting these parts is not particularly limited as long as the electroplated layer 4 can be formed on the metal by electroplating and may be appropriately selected depending on the use of the plated material produced using the metal sheet 10. In view of the easiness of the formation of the electroplated layer, the parts to be plated 1, the connector parts 3 and the frame part 2 are preferably made of at least one metal selected from the group consisting of Ti, Ta, Nb, Zr, Cu and Ni. In the metal sheet 10 of the embodiment, the parts to be plated 1, the frame part 2 and the connector parts 3 are generally made of a same metal but may be made of different metals. Moreover, the structure of the parts to be plated 1, the frame part 2 and the connector parts 3 may be composed of a composite material such as a fiber assembly and a clad material as long as the parts are made of a metal. The metallic composition of the parts to be plated 1, the frame part 2 and the connector parts 3 may be a composite material such as SUS (Steel Use Stainless or stainless steel), which is an industrial versatile metal, or a composite material containing a material other than metals such as carbon steel. In view of the costs and the corrosion resistance, SUS is preferable.

The method for producing the metal sheet 10 of the embodiment is not particularly limited, but for example, the metal sheet 10 can be produced by blanking a metal sheet.

In the metal sheet 10, the thicknesses of the parts to be plated 1, the connector parts 3 and the frame part 2 may be different or the same, but the thicknesses of the parts are basically the same when the metal sheet 10 is produced by processing a metal sheet as described above. A preferable range of the thickness of the metal sheet 10, namely the thicknesses of the parts to be plated 1, the connector parts 3 and the frame part 2, varies with the metal constituting the metal sheet 10. When the thickness is too small, the strength of the metal sheet 10 may be insufficient, and distortion or the like may be caused. When the thickness is too large, the separation of the connector parts 3 and the parts to be plated 1 may become difficult. For example, when the metal sheet 10 is made of Ti, the thickness of the metal sheet 10 is preferably 0.1 mm or more and preferably 2.0 mm or less.

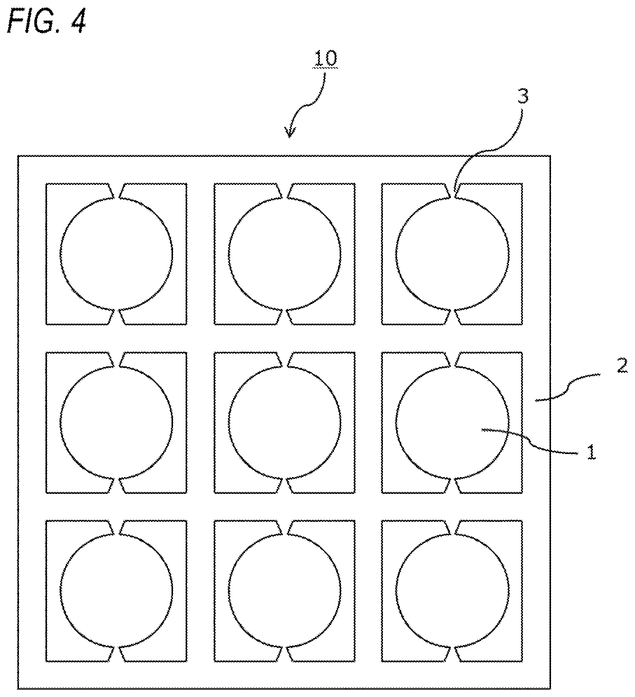

In the embodiment illustrated in FIG. 1, the metal sheet has five parts to be plated 1 which are aligned in a line, the frame part 2 which is formed to surround each part to be plated 1 and two connector parts per one part to be plated 1, but the metal sheet 10 is not limited to such a structure. For example, as in the modification example illustrated in FIG. 4, the parts to be plated 1 may be aligned in rows in the metal sheet 10.

The shape of the parts to be plated 1 in the embodiment is not particularly limited and can be any shape depending on the use of the plated materials 20 to be produced using the metal sheet 10 of the embodiment. For example, the shape of the parts to be plated 1 is a circle in the embodiment illustrated in FIG. 1, but the shape may be another shape such as quadrangle. Depending on the use of the plated materials 20, the parts to be plated 1 may be subjected to processing such as drilling, surface treatment or the like.

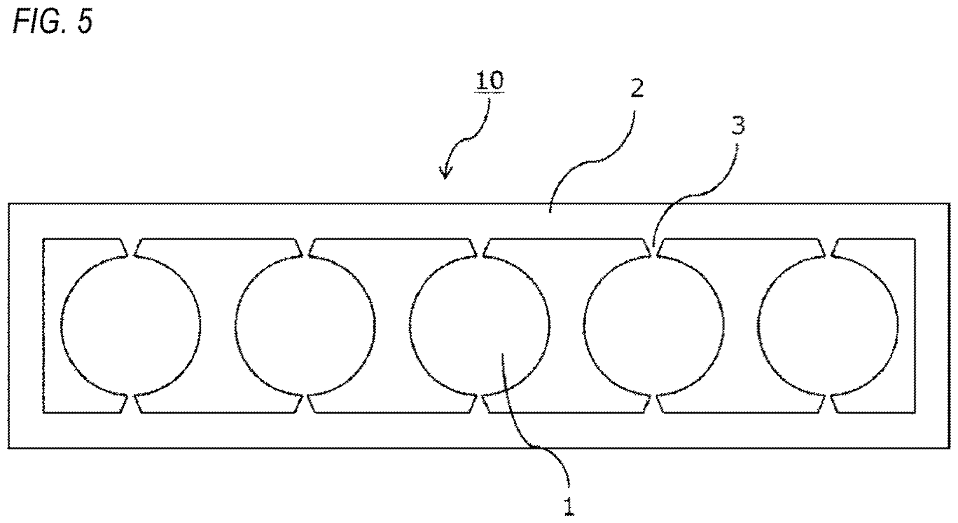

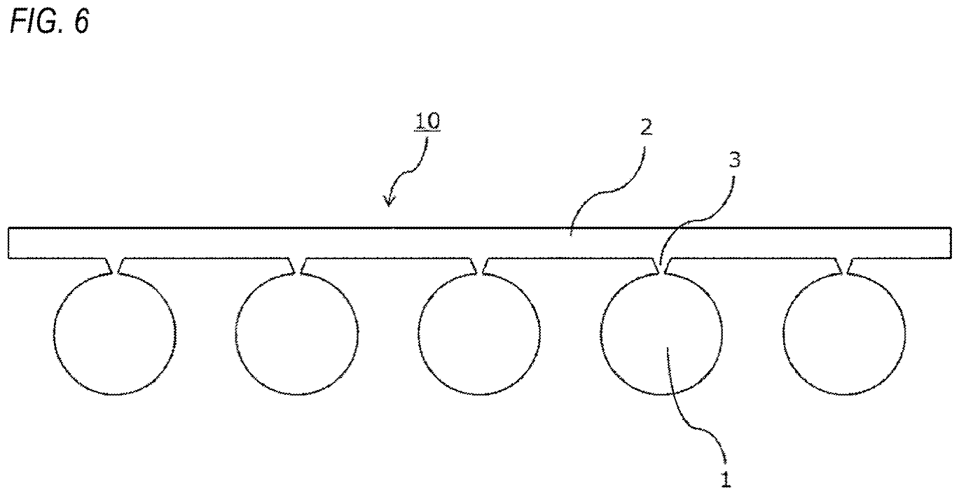

The shape or the like of the frame part 2 in the embodiment is not particularly limited as long as the frame part 2 has a portion which the jig or the like is brought into contact with for the electroplating and as long as the frame part 2 is connected to the parts to be plated 1 through the connector parts 3. The frame part 2 is formed to surround each part to be plated 1 in the embodiment illustrated in FIG. 1 and in the modification example illustrated in FIG. 4, but the frame part 2 may be formed to surround the parts to be plated 1 together, for example, as in the modification example illustrated in FIG. 5. Moreover, the frame part 2 does not have to be formed to surround the parts to be plated 1 and may be provided only on one side of the parts to be plated 1, for example, as in the modification example illustrated in FIG. 6.

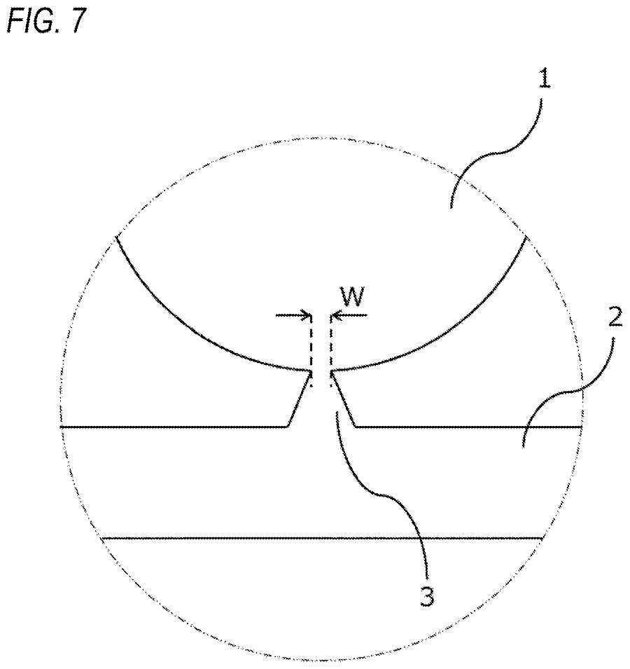

FIG. 7 is an enlarged view of the metal sheet 10 of the embodiment around a connector part 3. The shape of the connector parts 3 is not particularly limited but is preferably a shape which becomes narrower towards the part to be plated 1 side from the frame part 2 side as illustrated in FIG. 7. With such a shape, separation at the portion where the connector part 3 is connected to the part to be plated 1 is caused easily when the connector part 3 and the part to be plated 1 are separated, and the connector part 3 does not easily remain on the part to be plated 1 as a burr. In particular, the connector parts 3 preferably have an approximate triangle shape which continuously becomes narrower towards the part to be plated 1 side from the frame part 2 side as illustrated in FIG. 7.

The width W of the portion of the connector part 3 which is connected to the part to be plated 1 (also simply called “width W” below) is preferably 0.5 mm or less. Such a width W is preferable because separation is easy to be conducted also when the connector part 3 and the part to be plated 1 are separated manually without using a machine. The obtained plated material 20 has a very small defect of the electroplated layer 4 at the portion where the part to be plated 1 and the connector part 3 were connected, but the width W of 1 mm or less is preferable because the defect of the electroplated layer 4 is particularly small.

The lower limit of the width W is not particularly limited as long as the width is a width which secures the conduction to the part to be plated 1.

The number of the connector parts 3 is not particularly limited, and at least one or more connector parts 3 should be provided for one part to be plated 1. One connector part may be provided for one part to be plated 1 as in the example illustrated in FIG. 6. Moreover, two connector parts may be provided for one part to be plated 1 as in the example illustrated in FIG. 1, 4 or 5. Furthermore, three or more connector parts may be provided for one part to be plated 1.

To excellently apply a current to the parts to be plated 1 and to increase the efficiency of the formation of the electroplated layer 4, two or more connector parts 3 are preferably provided for one part to be plated 1. On the other hand, when the number of the connector parts 3 for one part to be plated 1 becomes high, the working property of separating the connector parts 3 and the parts to be plated 1 decreases. In particular, in view of the working property of manual separation, the number of the connector parts 3 for one part to be plated 1 is preferably two or less.

The use of the plated material 20 produced using the metal sheet 10 of the embodiment is not particularly limited, but examples include an electrode used for electrolysis of water, an electric feeder and the like.

In particular, when the plated material 20 obtained using the metal sheet 10 of the embodiment is used as an electrode for electrolysis of water, the parts to be plated 1, the frame part 2 and the connector parts 3 of the embodiment are preferably made of a passive metal (valve metal) in view of the durability. Here, a passive metal is a metal having corrosion resistance which forms a passive layer such as an oxide film on the surface, and major examples are metals belonging to group 4, group 5, group 6 and group 13 of the periodic table and alloys thereof. Typical metals are Al, Cr, Ti, Ta, Nb, Zr, Hf, Zn, W, Bi and the like. As alloy materials which are passive metals are SUS, Ti alloys, Ni alloys and the like.

Examples of SUS include SUS304, SUS430 and the like. Examples of Ti alloys include alloys of Ti and at least one metal of Al, V. Mo, Pd, Mn, Sn and Fe and the like. Examples of the crystal structures of Ti alloys include type α (α alloys), type α+β (α+β alloys), type β (β alloys) and the like. Examples of Ni alloys include alloys of Ni and at least one metal of Fe, Cr, Nb and Mo and the like. Specific examples include Inconel (registered trademark), Hastelloy (registered trademark) and the like.

In particular, in view of the strength, the heat resistance and the corrosion resistance, the pars are preferably made of at least one metal selected from the group consisting of Ti, Ta, Nb and Zr or SUS. In view of the processability, the costs, the light weight and the safety, the parts are particularly preferably made of Ti.

In this case, the electroplated layer 4 formed on the surfaces of the parts to be plated 1 is preferably made of a noble metal or, in other words, made of at least one metal selected from the group consisting of Pt, Au, Ag, Ir, Ru, Rh, Pd and Os. In particular, Pt is preferable because Pt does not dissolve and can tolerate the polarity reversal, and Ir and Ru are strong as an anode and are thus preferable. Therefore, the electroplated layer 4 is particularly preferably made of at least one metal selected from the group consisting of Pt, Ir and Ru. Moreover, the parts to be plated 1 are preferably subjected to drilling so that water can pass through.

Although the invention has been explained in detail using specific aspects, it is obvious to one skilled in the art that various changes and modifications are possible without departing from the intension and the scope of the invention. The present application is based on a Japanese patent application filed on Dec. 27, 2018 (patent application No. 2018-245929), which is incorporated by reference in its entirety.

### REFERENCE SIGNS LIST

1. Part to be plated
2. Frame part
3. Connector part
4. Electroplated layer
10. Metal sheet
20. Plated material

1. A metal sheet having a plurality of parts to be plated, a frame part and connector parts connecting the parts to be plated and the frame part, wherein the plurality of the parts to be plated, the frame part and the connector parts are made of a metal.

2. The metal sheet according to claim 1 which is a parts-to-be-plated-integrated electroplating jig used for forming an electroplated layer at least on the surfaces of the parts to be plated by applying a current to the parts to be plated from the frame part through the connector parts.

3. The metal sheet according to claim 1, wherein the connector parts have a shape which becomes narrower towards the part to be plated side from the frame part side.

4. The metal sheet according to claim 1, wherein the widths of the portions of the connector parts which are connected to the parts to be plated are 1 mm or less.

5. The metal sheet according to claim 1, wherein two or more connector parts are connected to a part to be plated.

6. A plated sheet having the metal sheet according to claim 1 and an electroplated layer formed on the surface of the metal sheet.

7. The plated sheet according to claim 6, wherein the electroplated layer is made of a noble metal.

8. A method for producing a plated sheet including a step of electroplating the metal sheet according to claim 1 by applying a current from the frame part and forming an electroplated layer on the surface of the metal sheet.

9. A method for producing a plated material including a step of electroplating the metal sheet according to claim 1 by applying a current from the frame part, forming an electroplated layer on the surface of the metal sheet and obtaining a plated sheet and a step of separating the parts to be plated and the connector parts of the plated sheet.

10. A method for producing a plated material including a step of separating the parts to be plated and the connector parts of the plated sheet according to claim 6.

11. The method for producing a plated material according to claim 9 which further includes a step of collecting a metal contained in the electroplated layer from a scrap obtained after separating the parts to be plated and the connector parts of the plated sheet.

12. A method for collecting a plating metal including collecting a metal contained in the electroplated layer from a scrap obtained after separating the parts to be plated and the connector parts of the plated sheet according to claim 6.
